(19) United States
(12) Patent Application Publication
(10) Pub. No.: US 2013/0104849 A1
(43) Pub. Date: May 2, 2013

(54) VAPOR RELIEF SYSTEM FOR FUEL INJECTOR

(71) Applicant: Briggs & Stratton Corporation, Wauwatosa, WI (US)

(72) Inventors: Patrick J. Bruener, Hartland, WI (US); David Duch, Sussex, WI (US); Cory Heipp, Kewaskum, WI (US)

(73) Assignee: Briggs & Stratton Corporation, Wauwatosa, WI (US)

(21) Appl. No.: 13/664,229

(22) Filed: Oct. 30, 2012

Related U.S. Application Data
(60) Provisional application No. 61/553,821, filed on Oct. 31, 2011.
(60) Provisional application No. 61/584,706, filed on Jan. 9, 2012.

(51) Int. Cl. F02M 33/08

(52) U.S. Cl. 123/445

(57) ABSTRACT

A fuel injection system includes a fuel tank configured to contain fuel, an injector fluidly connected to the fuel tank by a flow path, a pump disposed along the flow path and configured to deliver fuel to the injector, and a vapor relief passage in fluid communication with the flow path and the fuel tank. The vapor relief passage is fluidly connected to the flow path at an opening and allows vaporized fuel to return to the fuel tank from the flow path.

### CROSS-REFERENCE TO RELATED PATENT APPLICATIONS

This application claims the benefit of Application No. 61/553,821, filed Oct. 31, 2011, which is herein incorporated by reference in its entirety. This application claims the benefit of Application No. 61/584,706, filed Jan. 9, 2012, which is herein incorporated by reference in its entirety.

### BACKGROUND

The present disclosure relates to fuel injection systems for internal combustion engines.

Internal combustion engines generate waste heat during operation. This waste heat is absorbed by the engine block and other components of the engine, and can linger long after the engine has stopped operating, sometimes called “heat soak.” Residual fuel remaining in the supply system for the engine can be exposed to this lingering heat (e.g., to temperatures in the range of 150-200° F.) and be vaporized. Restarting an internal combustion engine while the engine is still hot (“hot starting”) can be troublesome when too much vaporized fuel is present in the fuel supply system, blocking the normal flow of liquid fuel. Further, if vaporized fuel advances up the supply line and into the fuel pump, the operation of the fuel pump may become compromised.

Internal combustion engines, such as small engines used for such devices as lawn mowers, snow blowers, portable generators, etc., using carburetors to create a fuel/air mixture are well known. Fuel in carburetors for small engines is typically retained in a bowl or reservoir spaced slightly away from the main body of the carburetor, slightly reducing the effects of the heat soak. Further, carburetors are partially open systems. As such, vaporized fuel can escape the carburetor through vents provided in the carburetor body.

With an electronic fuel injection (EFI) system, fuel is atomized as it actively sprayed into the air stream instead of relying on low pressure caused by a Venturi effect as in a carburetor system. Unlike carburetor systems, electronic fuel injection systems are generally closed systems that do not have venting to allow vaporized fuel to escape, the only available paths being back up the fuel supply line toward the fuel tank, through the pressure regulator, or through the injector. Because of this, vaporized fuel can become trapped in the pump and/or passages of the EFI system, making it difficult to pump liquid fuel past the vapor. Further, if vaporized fuel enters the fuel pump, it can be difficult for the pump to operate and deliver liquid fuel to the injector.

### SUMMARY

One embodiment of the invention relates to a fuel injection system including a fuel tank configured to contain fuel, an injector fluidly connected to the fuel tank by a flow path, a pump disposed along the flow path and configured to deliver fuel to the injector, and a vapor relief passage in fluid communication with the flow path and the fuel tank. The vapor relief passage is fluidly connected to the flow path at an opening and allows vaporized fuel to return to the fuel tank from the flow path.

Another embodiment of the invention relates to a fuel injection system including a fuel tank configured to contain fuel, an injector fluidly connected to the fuel tank by a flow path, a pump disposed along the flow path and configured to deliver fuel to the injector, a fuel separator disposed along the flow path and configured to separate liquid fuel from vaporized fuel, and a vapor relief passage in fluid communication with the fuel separator and the fuel tank. The vapor relief passage is fluidly connected to the fuel separator at an opening and allows vaporized fuel to return to the fuel tank from the flow path.

Another embodiment of the invention relates to a method for venting vaporized fuel from a fuel injection system. The method includes delivering fuel from a fuel tank to an injector via a flow path, providing a vapor relief passage with a first end in fluid communication with the fuel tank and a second end in fluid communication with the flow path, and directing vaporized fuel from the flow path to the fuel tank through the vapor relief passage.

### BRIEF DESCRIPTION OF THE DRAWINGS

The disclosure will become more fully understood from the following detailed description, taken in conjunction with the accompanying figures.

FIG. 1 is a schematic view of a portion of a fuel injection system including a vapor relief passage at an exemplary location, in accordance with an exemplary embodiment.

FIG. 2 is a schematic view of a portion of the fuel injection system of FIG. 1, including the vapor relief passage at an alternative location.

FIG. 3 is a schematic view of a portion of the fuel injection system of FIG. 1, including the vapor relief passage at an alternative location.

FIG. 4 is a schematic view of a portion of the fuel injection system of FIG. 1, including the vapor relief passage at an alternative location.

FIG. 5 is a schematic view of a portion of the fuel injection system of FIG. 1, including a valve to control flow through the vapor relief passage.

### DETAILED DESCRIPTION

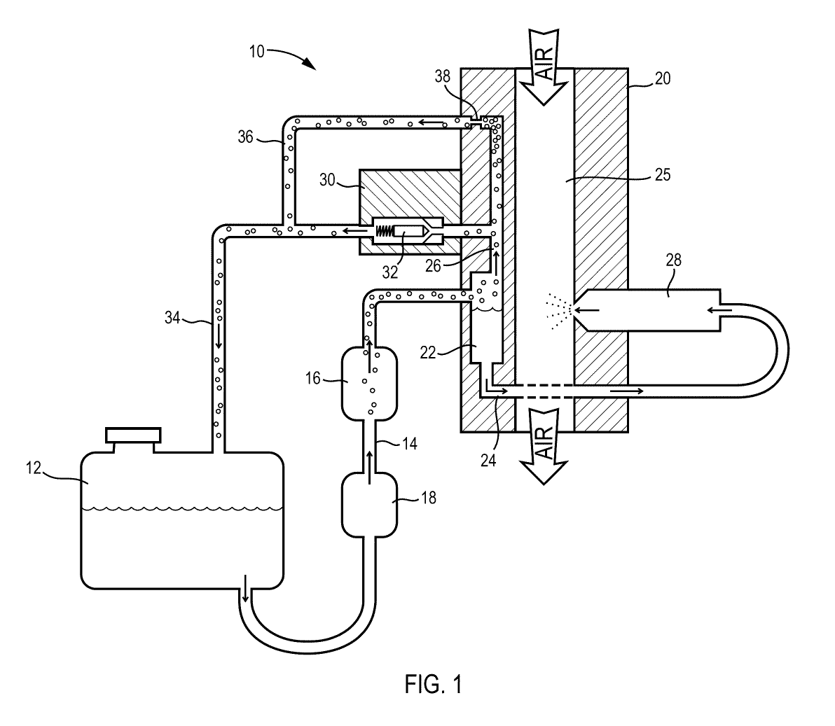

Referring in general to the FIGS. 1-5, fuel from a fuel supply is delivered by an EFI system (e.g., using a fuel pump) to the throttle body of a small engine where an injector nozzle atomizes the fuel and sprays the fuel into an air stream. The fuel/air mix is then delivered to one or more cylinders for the small engine where it is combusted. Some of the fuel in the EFI system may become vaporized, such as at the fuel pump or due to heat soak. Vaporized fuel can become trapped in the pump and/or passages of the EFI system, making it difficult to pump liquid fuel past the vapor. Accordingly, a vapor relief passage is provided in the EFI system at the pump or between the pump and the injector. The vapor relief passage may be connected to the fuel supply (e.g., fuel tank), maintaining the EFI system as a closed system. The vapor relief passage may direct vaporized fuel through an opening in a passage (e.g., tube, chamber, etc.) through which the fuel flows or may direct vaporized fuel through an opening in a device configured to separate liquid fuel from vaporized fuel. An orifice or other flow restriction may be located at or near the opening to the vapor relief passage. In either configuration, some liquid fuel may be returned to the fuel supply through the vapor relief passage along with the vaporized fuel. The opening through which the fuel enters the vapor relief passage may be sized to minimize the amount of liquid fuel that is allowed into the vapor relief passage. The opening to the vapor relief passage, the orifice of the vapor relief passage, and/or the vapor relief passage itself may be sized to have a minimal effect on the internal pressure of the EFI system.

A vapor relief passage, as described below with respect to the EFI system, also facilitates the venting of air from the fuel injection system. Air may need to be vented from the system, for instance, if the engine is being fueled for the first time or if the engine is refueled after having run out of fuel.

Referring to FIG. 1, a schematic view of a portion of an exemplary EFI system 10 for an engine is shown. Fuel is delivered from a fuel tank 12 through a supply line 14 by a pump 16 to the throttle body 20. The pump 16 may be any type of suitable pump known in the art (e.g., a turbine-style pump, a rotary pump, a pulse pump, a reciprocating pump, etc.). In other embodiments, the fuel tank 12 may be located above the throttle body 20 and fuel may be delivered by gravity instead of via a pump. While the pump 16 is shown in FIG. 1 as an in-line pump provided along the supply line 14 between the fuel tank 12 and the throttle body 20, in other exemplary embodiments, the pump may be an in-tank pump provided within the fuel tank 12. In other embodiments, a second pump may be provided in a chamber or reservoir of a fuel module or mini-tank, which can be inside or coupled to the throttle body or another engine component (e.g., the engine block, between the cylinders, etc.). A fuel filter 18 is provided to filter out contaminants from the fuel. In other embodiments, one or more fuel filters may be provided at other points along the flow path. FIG. 1 illustrates a scenario in which vaporized fuel is in the supply line 14 between the throttle body 20 and the fuel pump 16. Vaporized fuel in the EFI system 10 is illustrated as round bubbles.

The fuel is received in an inlet chamber 22 (e.g., reservoir, etc.) of the throttle body 20 that opens into a first passage 24 and a second passage 26. The first passage 24 is connected to the lower portion of the inlet chamber and extends to an injector 28, the injector 28 forming a nozzle through which liquid fuel is atomized and sprayed into the central passage 25 of the throttle body 20 to be mixed with air. While the throttle body 20 as shown in FIG. 1 is oriented such that the airflow through the central passage 25 is from top to bottom, in other embodiments, the airflow may be reversed. In other exemplary embodiments, the injector 28 may be configured to spray the fuel elsewhere, such as in the intake ports for the engine (not shown). The second passage 26 is connected to the upper portion of the inlet chamber 22 and extends to a pressure regulator 30. During normal operation, the inlet chamber 22 functions to partially separate a mixture of liquid and vaporized fuel, with the liquid fuel exiting the inlet chamber 22 through the first passage 24 and the vaporized fuel exiting the inlet chamber 22 through the second passage 26. A portion of the liquid fuel mixed with the vaporized fuel may also exit through the second passage 26.

The pressure regulator 30 is configured to maintain the EFI system 10 at a predetermined operational pressure. According to one exemplary embodiment, the EFI system 10 operates at a pressure of approximately 6 psi. According to another exemplary embodiment, the EFI system operates at a higher pressure, in the range of approximately 40-50 psi. In other embodiments, the EFI system may have an operational pressure in another pressure range.

At pressures above the predetermined limit, a pressure control valve 32 (e.g., pressure control valve) in the pressure regulator 30 opens, allowing fuel (vapor and liquid) to escape the second passage 26 and return to the fuel tank 12 via a return line 34.

Further referring to FIG. 1, a vapor relief passage 36 (e.g., bleeder, vent, etc.) is provided between the fuel pump 16 and the injector 28 through which vaporized fuel may return to the fuel tank 12. One end of the vapor relief passage 36 is located between the fuel pump 16 and the injector 28. According to an exemplary embodiment, the vapor relief passage 36 is connected on one end to the second passage 26 and on the other end to the return line 34. The vapor relief passage 36 thereby acts as a bypass of the pressure regulator 30. Vaporized fuel may flow through the vapor relief passage 36 and flow back to the fuel tank 12 via the return line 34. Liquid fuel is then free to flow through the supply line 14 to the inlet chamber 22 and then through the first passage 24 to the injector 28, addressing the hot start issues discussed above. The vapor relief passage 36 allows vaporized fuel to return to the fuel tank 12 even at very low pressures (e.g., pressures resulting from the vapor itself) before the EFI system 10 is at a full operational pressure.

The vapor relief passage 36 is connected to the second passage 26 by a flow restricting opening 38. As illustrated in FIG. 1, the opening 38 is a flow restricting orifice with a relatively small diameter that reduces the amount of liquid fuel that will pass from the second passage 26 to the vapor relief passage 36 while maintaining the operating pressure of the EFI system 10. The opening 38 may be the same diameter as the vapor relief passage and/or the second passage 26 or may have a diameter smaller than the diameter of the vapor relief passage 36 or the second passage 26.

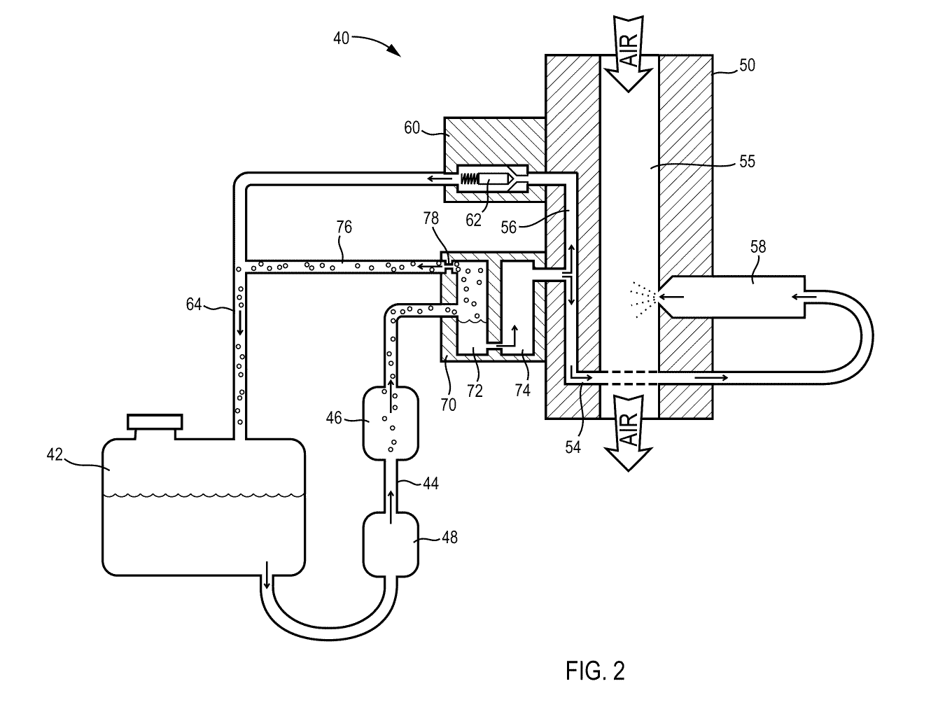

Referring now to FIG. 2, a schematic view of a portion of another exemplary EFI system 40 for a small engine is shown. The EFI system 40 of FIG. 2 is similar to the EFI system 10 of FIG. 1 and includes a fuel tank 42 that supplies fuel to a throttle body 50 via a fuel pump 46 and a fuel filter 48 along a supply line 44 with the addition of a fuel separator 70 configured to separate vaporized fuel from liquid fuel. The pump 46 keeps the separator 70 supplied with fuel. The separator 70 may be provided in the throttle body 50, may be coupled to the throttle body 50, or may be located away from the throttle body 50 (e.g., along the supply line). According to an exemplary embodiment, the separator 70 may be one or more chambers configured to separate vaporized fuel from liquid fuel. According to another exemplary embodiment, the separator 70 may be a component of a mechanical or electric pump that is configured to both separate vaporized fuel from liquid fuel but also to pump the liquid fuel through the EFI system 40.

The separator 70 includes an inlet chamber 72 (e.g., a first chamber, a low pressure chamber, etc.) and an outlet chamber 74 (e.g., a second chamber, a high pressure chamber, etc.). The inlet chamber 72 may be coupled to the outlet chamber 74 with a check valve such that fuel may pass from the inlet chamber 72 to the outlet chamber 74, but not backwards from the outlet chamber 74 to the inlet chamber 72. Fuel is pumped into the inlet chamber 72 of the separator 70 from the fuel tank 42 through the supply line 44 by the pump 46. The fuel is then allowed to pass or is pumped to the outlet chamber 74 and through a first passage 54 to an injector 58 through which it enters a central passage 55 of the throttle body 50 to mix with air. A second passage 56 is provided between the separator 70 and a pressure regulator 60 with a pressure control valve 62.

Further referring to FIG. 2, a vapor relief passage (e.g., bleeder, vent, etc.) 76 is provided through which vaporized fuel may return to the fuel tank 42. According to an exemplary embodiment, as shown in FIG. 2, the vapor relief passage 76 is connected on one end to the inlet chamber 72 of the separator 70 and on the other end to a return line 64 running from the pressure regulator 60 to the fuel tank 42. The vapor relief passage 76 thereby acts as a bypass of the pressure regulator 60 and the outlet chamber 74 of the separator 70. Vaporized fuel may flow through the vapor relief passage 76 and flow back to the fuel tank 42 via the return line 64. Liquid fuel is then free to flow through the supply line 44 and the inlet chamber 72 to the outlet chamber 74 and then through the first passage 54 to the injector 58. Like the vapor relief passage 36 of the EFI system 10 in FIG. 1, an opening 78 is provided between the inlet chamber 72 and the vapor relief passage 76 of the EFI system 40 in FIG. 2. The vapor relief passage 76 allows vaporized fuel to return to the fuel tank 42 even at very low pressures (e.g., pressures resulting from the vapor itself) before the EFI system 40 is at a full operational pressure. As illustrated in FIG. 2, the opening 78 is a flow restricting orifice. In embodiments where the separator 70 is a component of a pump, the opening may be formed in the inlet chamber or side of the pump without an orifice or other flow restriction because the fuel in the inlet chamber is at a relatively low pressure so any vaporized fuel can freely flow through the opening 78 to the vapor relief passage 76 with minimal amounts of liquid fuel also flowing through the opening. If the opening 78 is formed on the outlet chamber or side of the pump, in a preferred embodiment, the opening 78 includes an orifice or other flow restriction to help ensure that primarily vaporized fuel and not liquid fuel enters the vapor relief passage 76 through the opening 78.

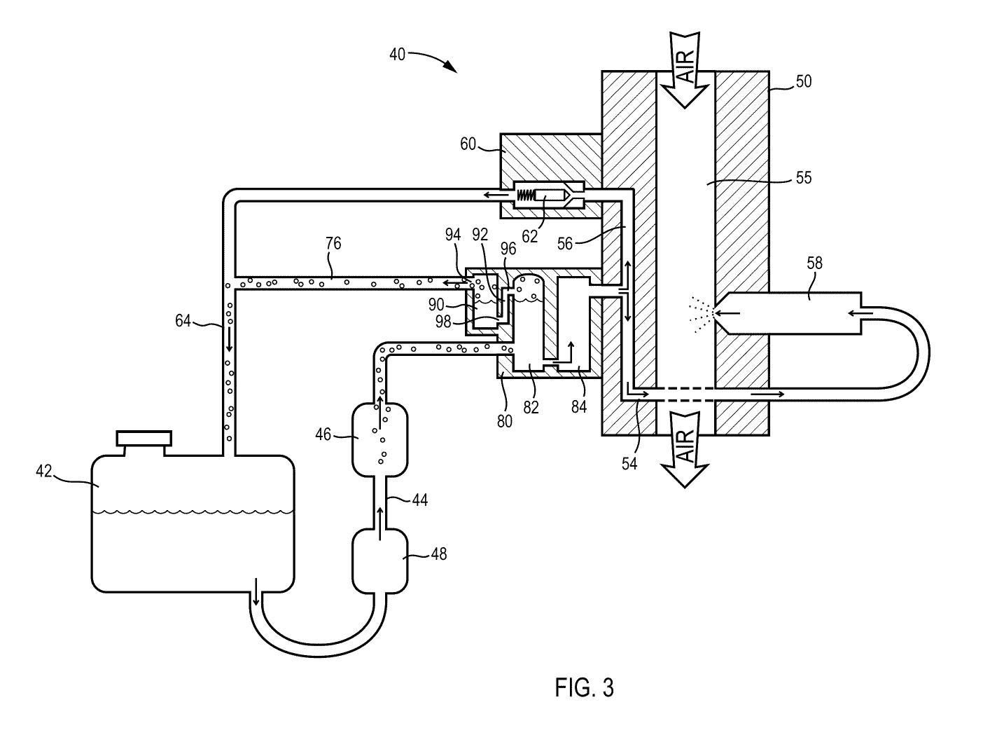

Referring now to FIG. 3, the EFI system 40 is illustrated with an alternative separator 80 replacing the separator 70 illustrated in FIG. 2. The separator 80 includes an inlet chamber 82 (e.g., a first chamber, a low pressure chamber, etc.), an outlet chamber 84 (e.g., a second chamber, a high pressure chamber, etc.) and an additional relief chamber 90. The inlet chamber 82 receives fluid via the supply line 14 and is in fluid communication with the outlet chamber 84. The inlet chamber 82 may be coupled to the outlet chamber 84 with a check valve, such that fuel may pass from the inlet chamber 82 to the outlet chamber 84, but not backwards from the outlet chamber 84 to the inlet chamber 82.

The relief chamber 90 is provided proximate to the inlet chamber 82. A vapor relief passage is formed by a first aperture 92 between the inlet chamber 82 and the relief chamber 90, the relief chamber 90 itself, and a second aperture 94. The vapor relief passage 76 is connected on one end to the relief chamber 90 of the separator 80 through the second aperture 94 and on the other end to the return line 64.

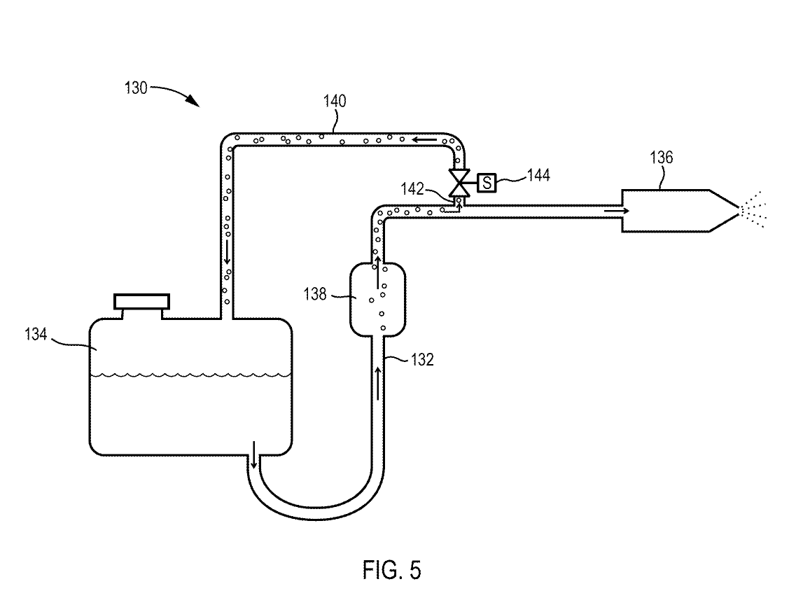

The first aperture 92 opens into the upper portion of the inlet chamber 82 to facilitate the venting of vaporized fuel from the inlet chamber 82. The first aperture 92 opens to a straight bore between the inlet chamber 82 and the relief chamber 90 or may open to an offset passage. As illustrated in FIG. 5, in one embodiment, the first end or inlet 96 of the first aperture 92 opens in the upper portion of the inlet chamber 82. The first aperture 92 then extends vertically along the wall between the inlet chamber 82 and the relief chamber 90. The second end or outlet 98 of the first aperture 92 opens into the lower portion of the relief chamber 90.

The second aperture 94 is located in the upper portion of the relief chamber 90 to facilitate the venting of vaporized fuel from the relief chamber 90. The first aperture 92 and the second aperture 94 may be integrally formed with the body of the separator 80 (e.g., by an injection molding process), or may be cut or otherwise machined in the body of the separator 80 during the manufacturing process.

In a hot start scenario, an excessive amount of residual vaporized fuel may remain in the EFI system 40 including the separator 80. The vapor relief passage formed by the relief chamber 90 and the apertures 92 and 94 allows the vaporized fuel to vent from the inlet chamber 82. The vaporized fuel escapes from the inlet chamber 82 through the first aperture 92 to the relief chamber 90. Some liquid fuel may also flow through the first aperture 92 to the relief chamber 90. Positive pressure pushes vaporized fuel out of the inlet chamber 82 through the first aperture 92 to the inlet chamber 82 before liquid fuel. Negative pressure draws liquid fuel back from the relief chamber 90 through the first aperture 92 to the inlet chamber 82 before vaporized fuel. Similarly, first the vaporized fuel and then liquid fuel escapes from the relief chamber 90 through the second aperture 94 and back to the fuel tank via the vapor relief passage 76 and the return line 64.

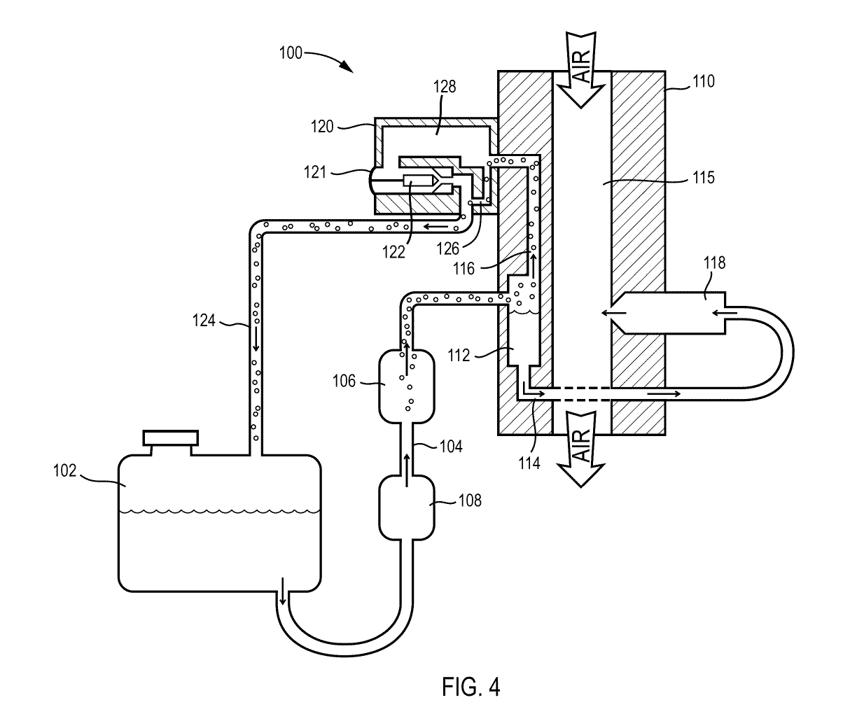

Referring now to FIG. 4, an EFI system 100 is shown according to another exemplary embodiment. The EFI system 100 of FIG. 6 is similar to the EFI system 10 of FIG. 1 and includes a fuel tank 102 that supplies fuel to a throttle body 110 via a fuel pump 106 and a fuel filter 108 along a supply line 104. The fuel is received in an inlet chamber 112 of the throttle body 110 that opens into a first passage 114 and a second passage 116. The first passage 114 is connected to the lower portion of the inlet chamber 112 and extends to an injector 118, the injector 118 forming a nozzle through which liquid fuel is atomized and sprayed into the central passage 115 of the throttle body 110 to be mixed with air. The second passage 116 is connected to the upper portion of the inlet chamber 112 and extends to a pressure regulator 120. The liquid fuel exits the inlet chamber 112 through the first passage 114 and the vaporized fuel exits the inlet chamber 112 through the second passage 116. A portion of the liquid fuel mixed with the vaporized fuel may also exit through the second passage 116.

Referring further to FIG. 4, a vapor relief passage 126 (e.g., bleeder, vent, etc.) is provided in the pressure regulator 120. According to an exemplary embodiment, the pressure regulator 120 includes a valve 122 that is coupled to a diaphragm 121. A pressure in the pressure regulator 120 above a predetermined threshold acts upon the diaphragm 121 to open the valve 122 and allow fuel to flow back to the fuel tank 102 via a return line 124. The vapor relief passage 126 is located in the body of the pressure regulator 120 and extends from the interior cavity 128 of the pressure regulator 120 to the return line 124 at a point upstream from the pressure control valve 122. Vaporized fuel may flow through the vapor relief passage 126 and flow back to the fuel tank 102 via the return line 124. The vapor relief passage 126 thereby acts as a bypass of the valve 122 to allow vaporized fuel to return to the fuel tank 102. The location of vapor relief passage 126 allows vaporized fuel to return to fuel tank 102 without relying on a pressure build-up within the pressure regulator 120 being great enough to activate the pressure control valve 122. The location of the vapor relief passage 126 purges vaporized fuel from not only the cavity 128 of the pressure regulator 120, but also from other components upstream from the pressure regulator 120 (e.g., supply line 104, inlet chamber 112, second passage 116, etc.), thereby improving the control of pressure in the EFI system 100. Accordingly, with the vaporized fuel vented back to the fuel tank 102, liquid fuel is free to flow through the supply line 104 to the inlet chamber 112 and then through the first passage 114 to the injector 118, addressing the hot start issues discussed above.

According to an exemplary embodiment, the vapor relief passage 126 has a diameter of about 0.5 mm-1 mm, which is large enough to allow vaporized fuel to pass through yet small enough to minimize the amount of liquid escaping through the vapor relief passage 126, minimizing the resulting pressure loss in the system 100 and thus allowing the pump 106 to develop pressure in the EFI system 100. Any pressure increases in the system 100 not attributable to vaporized fuel is mitigated by the pressure control valve 122.

While only a single vapor relief passage 126 is shown in FIG. 4, in other exemplary embodiments, more than one vapor relief passage may be provided in the pressure regulator 120. The diameter of the vapor relief passage 126 is large enough to allow vaporized fuel to pass through, yet small enough to not adversely effect the required pressure of the entire system by limiting the amount of liquid fuel that may pass through the vapor relief passage 126.

The vapor relief passage of the EFI systems described above and shown in FIGS. 1-4 may include a device such as a valve to control the flow through the vapor relief passage by selectively opening and closing the vapor relief passage. Referring to FIG. 5, a EFI system 130 is illustrated including a flow path 132 between a fuel tank 134 (e.g., fuel supply) and an injector 136. A pump 138 is included to deliver the fuel from the tank 134 through the flow path 132 to the injector 136. The flow path 132 may include a fuel line, a separator, one or more pumps, a pressure regulator, one or more fuel filters, or other components of an EFI system through which fuel flows between the fuel tank and an injector.

A vapor relief passage 140 is provided opening into the flow path 132 at an opening 142 to allow vaporized fuel to escape the flow path 132 and return to the fuel tank 134. Flow through the opening 142 is controlled using a valve 144. The valve 144 allows the EFI system 130 to selectively make use of the vapor relief passage 140 as needed. For example, in some embodiments, the valve 144 is configured to open to vent vaporized fuel, when needed to allow vaporized fuel to return to the fuel tank 134 (e.g., when the engine is off, during starting, while the engine is warming up, to avoid the hot restart issues described above, etc.). The valve may be continually open during these situations or sporadically open (e.g., cycled between open and closed). In some embodiments, the valve 144 may be configured to close to not allow vaporized fuel to return to the fuel tank 134 via the vapor relief passage 140 when needed to maintain pressure in the EFI system 130 by (e.g., after the engine is operating, after the engine has warmed up, etc.), thereby eliminating a pressure drop in the EFI system 130 caused by fuel (e.g., liquid fuel and/or vaporized fuel) returning to the fuel tank 134 via the vapor relief passage 140. In this way, the vapor relief passage 140 is open when it is needed (e.g., during engine starting, especially under hot-start conditions), but is closed when it is not needed (e.g., after the engine is running, after the engine is warmed up, etc.), thereby avoiding unnecessary loss of pressure at the injector 136. According to an exemplary embodiment, the valve 144 is a normally open solenoid valve. The valve 144 can be configured to close in response to one or more inputs. For example, the valve 144 may close based on a signal from the starter or keyswitch, in response to engine speed, in response to one or more temperatures (e.g. engine temperature and ambient temperature) or pressures, in response to a timer (e.g., elapsed time from starting the engine), or a combination of these or other appropriate inputs.

While the vapor relief passage is shown in FIGS. 1-4 as generally being formed in a throttle body or in components coupled to a throttle body (e.g., the separator 70, the separator 80, or the pressure regulator 120), in other embodiments, a vapor relief passage configured to allow vaporized fuel or air to escape the flow path may be provided elsewhere in the EFI system between the fuel pump and the injector. For example, the EFI system may include a fuel pump inside the fuel tank and the vapor relief passage may be provided inside the fuel tank to vent vaporized fuel from the outlet of the pump.

The construction and arrangements of the EFI system and components of the EFI system (e.g., the fuel pump and the pressure regulator), as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the invention.

What is claimed is:

1. A fuel injection system, comprising:
a fuel tank configured to contain fuel;
an injector fluidly connected to the fuel tank by a flow path;
a pump disposed along the flow path and configured to deliver fuel to the injector; and
a vapor relief passage in fluid communication with the flow path and the fuel tank, the vapor relief passage fluidly connected to the flow path at an opening;
wherein the vapor relief passage allows vaporized fuel to return to the fuel tank from the flow path.

2. The fuel injection system of claim 1, wherein the opening is disposed in the pump.

3. The fuel injection system of claim 1, wherein the opening is disposed between the pump and the injector.

4. The fuel injection system of claim 1, further comprising:
a pressure regulator in fluid communication with the flow path and the fuel tank, the pressure regulator having a pressure control valve configured to allow fuel to flow from the flow path to the fuel tank if the pressure upstream of the pressure control valve exceeds a predetermined pressure.

5. The fuel injection system of claim 4, wherein the vapor relief passage bypasses the pressure regulator, thereby allowing vaporized fuel to return to the fuel tank via the vapor relief passage at pressures below the predetermined pressure.

6. The fuel injection system of claim 4, wherein the vapor relief passage is disposed within the pressure regulator.

7. The fuel injection system of claim 1, wherein the pump and the vapor relief passage are disposed within the fuel tank.

8. The fuel injection system of claim 1, wherein the opening comprises an orifice having a diameter smaller than the flow path proximate to the opening.

9. The fuel injection system of claim 1, further comprising:
a valve configured to selectively open and close the vapor relief passage.

10. The fuel injection system of claim 1, further comprising:
a second pump downstream of the first pump such that the first pump delivers fuel to the second pump, the second pump configured to deliver fuel to the injector.

11. A fuel injection system, comprising:
a fuel tank configured to contain fuel;
an injector fluidly connected to the fuel tank by a flow path;
a pump disposed along the flow path and configured to deliver fuel to the injector;
a fuel separator disposed along the flow path, the fuel separator configured to separate liquid fuel from vaporized fuel; and
a vapor relief passage in fluid communication with the fuel separator and the fuel tank, the vapor relief passage fluidly connected to the fuel separator at an opening;
wherein the vapor relief passage allows vaporized fuel to return to the fuel tank from the flow path.

12. The fuel injection system of claim 10, further comprising:
a pressure regulator in fluid communication with the flow path and the fuel tank, the pressure regulator having a pressure control valve configured to allow fuel to flow from the flow path to the fuel tank if the pressure upstream of the pressure control valve exceeds a predetermined pressure.

13. The fuel injection system of claim 12, wherein the vapor relief passage bypasses the pressure regulator, thereby allowing vaporized fuel to return to the fuel tank via the vapor relief passage at pressures below the predetermined pressure.

14. The fuel injection system of claim 10, wherein the fuel separator is a component of the pump.

15. The fuel injection system of claim 10, wherein the fuel separator comprises:
a first chamber including the opening, the first chamber configured to separate vaporized fuel and liquid fuel; and
a second chamber in fluid communication with the first chamber and the injector, the second chamber configured to receive liquid fuel from the first chamber and provide liquid fuel to the injector.

16. The fuel injection system of claim 10, wherein the fuel separator is coupled to the throttle body.

17. A method for venting vaporized fuel from a fuel injection system, comprising:
delivering fuel from a fuel tank to an injector via a flow path;
providing a vapor relief passage with a first end in fluid communication with the fuel tank and a second end in fluid communication with the flow path; and
directing vaporized fuel from the flow path to the fuel tank through the vapor relief passage.

18. The method of claim 17, further comprising:
separating vaporized fuel from liquid fuel proximate the second end of the vapor relief passage.

19. The method of claim 18, wherein the second end of the vapor relief passage is in fluid communication with the separator through an orifice.

20. The method of claim 19, further comprising:
selectively opening and closing the vapor relief passage to control the flow of vaporized fuel through the vapor relief passage.
